(19) United States
(12) Patent Application Publication
(10) Pub. No.: US 2019/0385372 A1
(43) Pub. Date: Dec. 19, 2019

(54) POSITIONING A VIRTUAL REALITY PASSTHROUGH REGION AT A KNOWN DISTANCE

(71) Applicant: Microsoft Technology Licensing, LLC, Redmond, WA (US)

(72) Inventors: Luke CARTWRIGHT, Seattle, WA (US); Marcelo Alonso MEJIA COBO, Redmond, WA (US); Misbah URAIZEE, Bellevue, WA (US); Nicholas Ferianc KAMUDA, Seattle, WA (US)

(21) Appl. No.: 16/059,847

(22) Filed: Aug. 9, 2018

Related U.S. Application Data
(60) Provisional application No. 62/685,805, filed on Jun. 15, 2018.

(51) Int. Cl. G06T 19/00; H04N 5/222; G06F 3/01; G06K 9/00; G06T 15/20

(52) U.S. Cl. CPC G06T 19/006; H04N 5/2226; G06F 3/017; G06T 2215/16; G06T 15/20; G06T 19/003; G06K 9/00355

(57) ABSTRACT

A method for presenting a physical environment in a virtual environment includes presenting a virtual environment to a user with a near-eye display, imaging a physical environment of the user, identifying at least one surface in the physical environment, positioning a passthrough portal in the virtual environment, a position of the passthrough portal having a z-distance from the user in the virtual environment that is equal to a z-distance of the at least one surface in the physical environment, and presenting a video feed of the physical environment in the passthrough portal in the virtual environment.

### CROSS-REFERENCE TO RELATED APPLICATIONS

This application claims the benefit of and priority to U.S. Provisional Patent Application No. 62/685,805, filed on Jun. 15, 2018, which is hereby incorporated by reference in its entirety.

### BACKGROUND

### Background and Relevant Art

With emerging ubiquitous user interfaces (UI), such as smart devices and innovative head-mounted display technology, usage of such UIs becomes more common among non-specialists. Opaque head-mounted displays (HMDs), such as virtual and mixed reality HMDs, obscure a user's vision and replace a view of the physical environment with a displayed virtual environment presented on the near-eye displays of the HMD. While the presentation of a virtual environment allows for flexibility in the work or leisure environment of a user, some users prefer to maintain awareness of the physical environment during use. Therefore, the replacement of the physical environment with the virtual environment by an opaque head-mounted display remains a barrier to adoption of the technology.

### BRIEF SUMMARY

In some embodiments, a method for presenting a physical environment in a virtual environment includes presenting a virtual environment to a user with a near-eye display, imaging a physical environment of the user, identifying at least one surface in the physical environment, positioning a passthrough portal in the virtual environment, a position of the passthrough portal having a z-distance from the user in the virtual environment that is equal to a z-distance of the at least one surface in the physical environment, and presenting a video feed of the physical environment in the passthrough portal in the virtual environment.

In some embodiments, a system for presenting visual information to a user includes a near-eye display, at least one outward facing camera, and an input device. A processor is in data communication with the near-eye display, the input device, and the outward facing camera. A hardware storage device is in data communication with the processor and contains instructions thereon that, when executed by the processor, cause the system to: present a virtual environment to a user, image a physical environment of the user, identify at least one surface in the physical environment using the outward facing camera, position a passthrough portal in the virtual environment based on the location of the surface in the physical environment, and present a video feed of the physical environment in the passthrough portal of the virtual environment.

In some embodiments, a method for presenting a physical environment in a virtual environment includes presenting a virtual environment to a user with a head mounted display (HMD), imaging a physical environment of the user with a camera of the HMD, positioning a passthrough portal in the virtual environment at a sphere defined by a z-distance from an origin of the HMD, moving the passthrough portal on the sphere at a constant z-distance, and presenting a video feed of the physical environment in the passthrough portal in the virtual environment.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the disclosure may be realized and obtained by means of the instruments and combinations particularly pointed out in the appended claims. Features of the present disclosure will become more fully apparent from the following description and appended claims or may be learned by the practice of the disclosure as set forth hereinafter.

### BRIEF DESCRIPTION OF THE DRAWINGS

In order to describe the manner in which the above-recited and other features of the disclosure can be obtained, a more particular description will be rendered by reference to specific embodiments thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example embodiments, the embodiments will be described and explained with additional specificity and detail through the use of the accompanying drawings in which:

FIG. 1 is a perspective view of a head-mounted display (HMD) including a waveguide, according to at least one embodiment of the present disclosure;

FIG. 2 is a schematic representation of the HMD of FIG. 1, according to at least one embodiment of the present disclosure;

FIG. 3 is a perspective view of a HMD in a physical environment, according to at least one embodiment of the present disclosure;

FIG. 4 is a schematic representation of a virtual environment presented by the HMD, according to at least one embodiment of the present disclosure;

FIG. 5 is a flowchart illustrating a method of presenting a physical environment to a user of a virtual environment, according to at least one embodiment of the present disclosure;

FIG. 6 is a schematic representation of the virtual environment of FIG. 4 with an input device positioned at a stationary location in the virtual environment;

FIG. 7 is a schematic representation of the virtual environment of FIG. 6 with a passthrough portal to the physical environment of FIG. 3 based on the position of the input device, according to at least one embodiment of the present disclosure;

FIG. 8 is a schematic representation of a pair of passthrough portals positioned in a virtual environment, according to at least one embodiment of the present disclosure;

FIG. 9 is a schematic representation of the virtual environment of FIG. 8 with a bridge portion connecting the passthrough portals of FIG. 8 into a single passthrough portal, according to at least one embodiment of the present disclosure;

FIG. 10 is a schematic representation of the virtual environment of FIG. 8 with a single passthrough portal sized to a plurality of input devices, according to at least one embodiment of the present disclosure;

FIG. 11 is a flowchart illustrating a method of presenting a passthrough portal at a fixed z-distance, according to at least one embodiment of the present disclosure;

FIG. 12 is a schematic representation of positioning a passthrough portal at a fixed z-distance, according to at least one embodiment of the present disclosure;

FIG. 13 is a schematic representation of presenting a passthrough portal at a fixed z-distance, according to at least one embodiment of the present disclosure;

FIG. 14 is a schematic representation of resizing a passthrough portal at a fixed z-distance, according to at least one embodiment of the present disclosure; and

FIG. 15 is a schematic representation of repositioning a passthrough portal at a fixed z-distance, according to at least one embodiment of the present disclosure.

### DETAILED DESCRIPTION

This disclosure generally relates to devices, systems, and methods for presentation of part of a physical environment in a virtual environment. More specifically, the present disclosure relates to improving user experience with a virtual environment by allowing the user to receive visual information of the physical environment in a natural and intuitive manner in the virtual environment. In some embodiments, visual information may be provided to a user by a near-eye display. A near-eye display may be any display that is positioned near a user's eye, such as a liquid crystal display (LCD), light-emitting diode (LED) display, organic LED display, microelectromechanical system (MEMS) display, waveguide, or other device for directing light to a user.

In some embodiments, a virtual reality or mixed reality device may be a head-mounted display (HMD) that presents visual information to the user. An opaque near-eye display or HMD replaces the user's view of their surroundings. For example, the visual information from the HMD may be present on an opaque near-eye display or presented on a near-eye display in an opaque housing.

Visual information including virtual environments may be positioned in the user's field of view on the near-eye display. However, a user may choose to view the physical environment within the virtual environment by positioning a passthrough portal in the virtual environment that presents a video feed of the physical environment such that a user may maintain awareness of the physical environment while viewing the virtual environment presented by the opaque HMD. For some users, a visual representation of the physical environment positioned at a distance in the virtual environment that is different from a depth of the physical environment is discomforting, disorienting, or simply inconvenient. For example, a conventional passthrough that shows a video feed of the physical environment directly in front of a user lacks any depth information. The video feed, therefore, may show a desk in front of the user, but the user may be unable to easily determine how far to reach out to interact with a keyboard on the desk. In some embodiments according to the present disclosure, a passthrough portal may be positioned in the virtual environment at a known z-distance from the user and/or at a z-distance in the virtual environment equal to a z-distance of the physical environment to improve a user's interaction with the physical environment while immersed in the virtual environment of an opaque HMD.

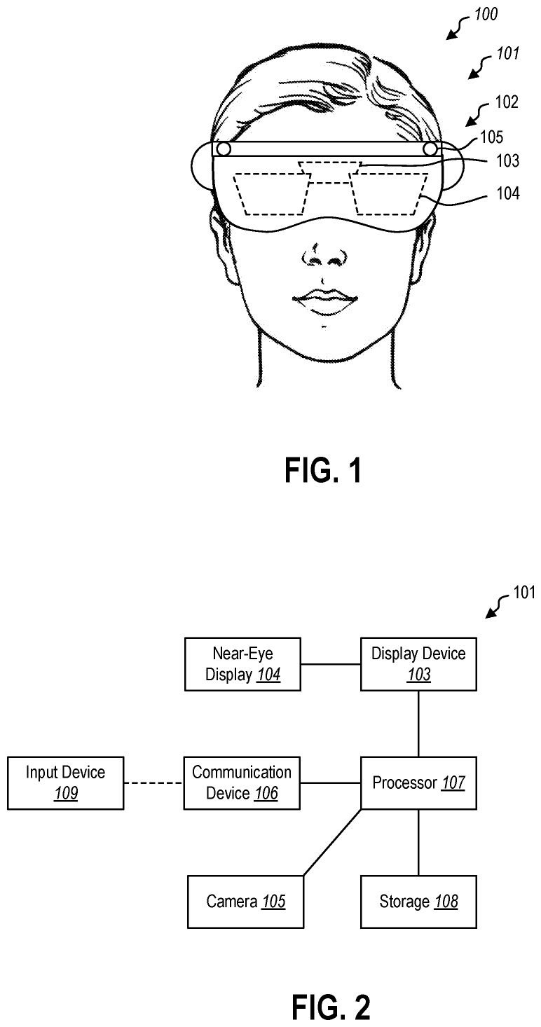

FIG. 1 is a front view of a user 100 wearing a HMD 101. In some embodiments, the HMD 101 may have a housing 102 that contains one or more processors, storage devices, power supplies, audio devices, display devices, cameras, communication devices, or combinations thereof, that receive, collect, store, process, or calculate information that is provided to the user. For example, a display device 103 may be in communication with a near-eye display 104 to provide visual information to the near-eye display 104, which may, in turn, be presented in the user's field of view by the near-eye display 104.

In other embodiments, the HMD 101 includes one or more audio devices, cameras, display devices, communication devices, or other components in communication with one or more processors, storage devices, communication devices, or other computing components. For example, the HMD 101 may be in data communication with a computing device such as a laptop, desktop computer, or other computing device that renders a virtual environment and provides the information to the HMD 101 to display to the user.

In some embodiments, the HMD 101 may have a near-eye display 104 positioned near the user 100 to direct visual information to the user 100. The HMD 101 may include a single near-eye display 104, a separate near-eye display 104 for each of the user's eyes (i.e., two near-eye displays 104), or more than two near-eye displays 104 to provide visual information over a larger field of view.

In some embodiments, the HMD 101 may include one or more outward facing cameras 105 that may image the user's physical environment. For example, the camera(s) 105 may include a visible light camera(s) 105 that may image the surrounding environment. A processor may perform image recognition routines on the visible light image to detect and recognize elements in the surrounding environment, such as physical objects or people. In other examples, the camera(s) 105 may include depth-sensing camera(s) that may create a depth image of the surrounding environment. For example, the camera 105 may be a time-of-flight camera, a structured light camera, stereo cameras, or other cameras that may use visible, infrared, ultraviolet, or other wavelengths of light to collect three-dimensional information about the surrounding environment. In at least one example, the camera(s) 105 may include gesture recognition cameras that allow the HMD 101 to recognize and interpret hand gestures performed by the user 100 in front of the HMD 101.

FIG. 2 is a schematic representation of the HMD 101. The display device 103 in communication with the near-eye display 104 may be in data communication with a processor 107. Similarly, the camera 105 may be in data communication with the processor 107. The processor 107 may further be in data communication with a storage device 108. The storage device 108 may be a hardware storage device, such as a platen-based storage device, a solid-state storage device, or other non-transitory or long-term storage device. The storage device 108 may have instructions stored thereon to perform one or more methods or portions of a method described herein. The processor 107 may further be in communication with a communication device 106, including a wired or wireless communication device, that communicates with one or more input devices 109 that allow a user to interact with the virtual environment presented by the HMD 101. In some examples, the input device 109 may include a mouse, a keyboard, a trackpad or other touch-sensing device, a multi-touch controller, a voice recognition device, a gesture recognition device, a gaze-tracking device such as an eye-tracking or head-tracking device, a motion controller such as 3-degree-of-freedom (3DOF) controller or a 6-degree-of-freedom (6DOF) controller, another peripheral controller, a smartphone or other handheld electronic device, or another device configured to interpret inputs from the user and communicate the inputs to the processor 107. The input device 109 is illustrated herein as a 6DOF controller. In some examples, a smartphone or other handheld electronic device may communicate with the HMD 101 an input device 109 including one or more accelerometers, gyroscopes, touch-sensing surfaces, multitouch surfaces, or other sensors to provide 3DOF, 6DOF, or other input information.

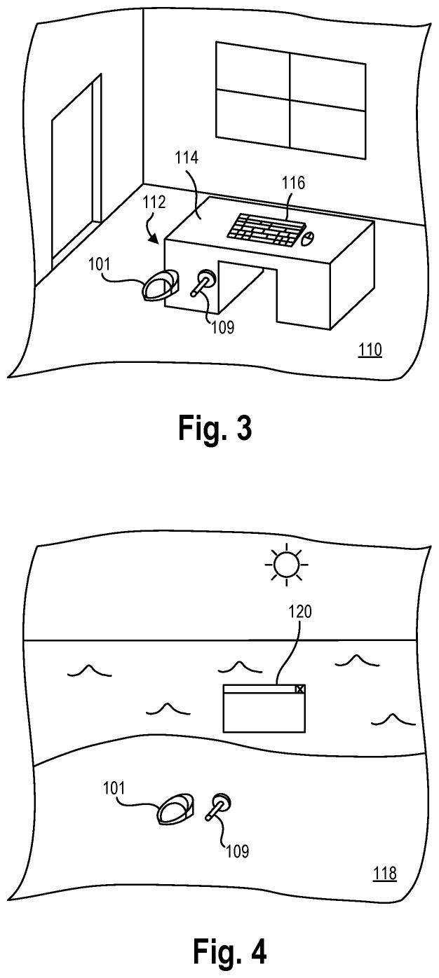

FIG. 3 is a perspective view of an example physical environment 110 in which a user uses a HMD 101 and input device 109. The physical environment 110 may include a plurality of physical objects, such as a door, a desk 112, a window, or other physical objects of which a user may want to maintain awareness while using the HMD 101 and input device 109. For example, the user may use the HMD 101 and input device 109 while working at a desk 112, but the user may desire to be able to view a surface 114 of the desk 112 or objects on the desk 112, such as a keyboard 116 or mouse. Additionally, the user may move around the physical environment 110 while using the HMD 101 and input device 109, and the user may want to maintain awareness of papers or other objects on a surface 114 of the desk 112 while wearing the HMD 101.

While using the HMD 101 in the physical environment 110, a user may experience a virtual environment 118, as shown in FIG. 4. The virtual environment 118 may include one or more virtual elements 120. For example, an application virtual element 120 may be presented to the user in the virtual environment 118. The virtual environment 118, itself, may be a remote location different from the physical environment 110. In FIG. 4, the virtual environment 118 is a beach, at which an application virtual element 120 is presented hovering above the beach. The user may use the input device 109 to interact with the virtual environment 118 and/or the virtual elements 120 of the virtual environment 118. In a conventional HMD 101 and virtual environment 118, the virtual environment 118 replaces the physical environment 110 of FIG. 3, and the user may lack awareness of objects or people in the physical environment 110.

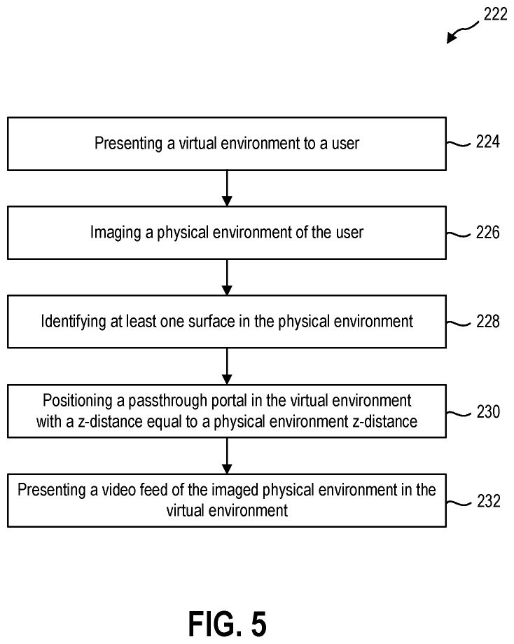

FIG. 5 is a flowchart illustrating a method 222 of presenting a portion of a physical environment in a virtual environment. The method 222 includes presenting a virtual environment to a user at 224. In some embodiments, the virtual environment may be a three-dimensional space generated by the HMD or other computing device in communication with the HMD. In other embodiments, the virtual environment may be part of a shared environment. For example, a mixed reality HMD may present a virtual environment in combination with a surface mesh measured from a surrounding physical environment of the user. In such embodiments, the HMD may measure the surrounding physical environment of the user using, for example, depth cameras on the HMD or other sensors to impart information of the surrounding physical environment into a virtual environment to create a shared environment. The HMD may then use the shared environment to position a virtual element in a virtual environment relative to a physical element of the surrounding physical environment.

The method 222 includes imaging a physical environment of the user at 226. One or more cameras of the HMD may image the physical environment in real time. For example, the cameras may be full color cameras of the visible light spectrum. In other examples, the camera may be a monochromatic camera that measures brightness of one wavelength (or a range of wavelengths) of light. In at least one example, the camera may be an actively illuminated camera that measures a reflected portion of a light provided by an illuminator on the HMD. For example, the camera may be an infrared camera and the HMD may include an infrared illuminator. The infrared camera may measure infrared light reflected to the camera, allowing the HMD to image the physical environment in low light situations without introducing visible light that may disturb other individuals near the user.

The method 222 further includes identifying at least one surface in the physical environment at 228. In some embodiments, the surface may be identified by a depth camera of the HMD imaging the physical environment and measuring depth information of the physical environment. For example, at least one camera of the HMD may be a time-of-flight camera, a structured light camera, stereo cameras, or other cameras that may allow the HMD or associated processor to detect a surface in the physical environment. In at least one embodiment, the camera may measure depth information and provide the depth information to the processor, and the processor may calculate a surface mesh that includes at least one horizontal surface in the physical environment.

In other embodiments, the system may identify a surface by tracking the position, orientation, movement, or combinations thereof of an input device (such as the motion controller input device 109 of FIG. 3 and FIG. 4). For example, the input device may be placed on a surface, and the input device may be tracked by the HMD or other portion of the system, such as a one or more tracking devices that track the position of the HMD and input device. The location of the input device is, therefore, known relative to the HMD, and the location of the input device, when positioned in a stationary location for a minimum amount of time, may be assumed to be on a horizontal surface. For example, when the system measures the location of the input device to be constant for at least 1 second (s), 1.5 s, 2 s, 2.5 s, 3 s, 5 s, or greater, the system may determine that the input device is on a horizontal surface (as the input device would otherwise not come to rest).

In another example, the camera(s) of the HMD may image the physical environment (such as the physical environment 110 of FIG. 3) and the processor may detect edges within the imaged physical environment. In at least one example, the processor may perform an edge detection function on the imaged physical environment by measuring areas of high contrast changes in the imaged physical environment. In other examples, the camera(s) may include a depth camera, and the processor may perform an edge detection function on the imaged physical environment by measuring areas of high depth changes in the imaged physical environment. The identified edges can be used to identify surfaces of the physical environment, such as a surface of a desk.

The method 222 further includes positioning a passthrough portal in the virtual environment with a z-distance equal to a physical environment z-distance at 230. A passthrough portal may be a two-dimensional (2D) virtual element that displays 2D visual information to the user related to the physical environment. Conventionally, a passthrough portal behaves as a video feed of an outward facing camera of the HMD, where the video feed is 2D. While the video feed from the outward facing camera provides information related to the physical environment, a conventional passthrough portal is located arbitrarily in the virtual environment and provides no depth information to the user corresponding to the physical environment, similar to viewing a tablet or other display device that is displaying a remote video feed. Positioning a 2D passthrough portal at a location in the virtual environment that corresponds to the flat surface identified at 228, however, may approximate a position of the physical surface in the virtual environment, providing context of the physical environment to the user in the virtual environment.

The passthrough portal is positioned in the virtual environment and the HMD then presents a video feed of that region of the imaged physical environment in the virtual environment via the passthrough portal at 232. For example, the passthrough portal may be positioned in the virtual environment to allow the user to view a corresponding portion of the physical environment imaged by the camera(s) of the HMD while viewing the virtual environment. In this manner, the passthrough portal acts as a “window” to the physical environment from the virtual environment. The user may desire to maintain awareness of an object in or area of the physical environment while interacting with the virtual environment. For example, a passthrough portal at a position in the virtual environment that corresponds to a surface on which a keyboard rests in the physical environment may allow a user to perceive the keyboard at the correct depth in the virtual environment to interact with the keyboard in the physical environment while using the HMD.

In some embodiments, the camera used to provide the video feed at 232 is the same as the camera used to image the physical environment at 226. For example, the camera may be a visible light camera that images the physical environment and is capable of full motion video. In other embodiments, a depth camera may image the physical environment at 226 and a visible light camera may capture the video feed.

In some examples, the cameras of the HMD may image the physical environment with a field-of-view (FOV) that is at least as large as the FOV of the virtual environment presented to the user by the near-eye display of the HMD. In such examples, whenever the passthrough portal is visible in the FOV of the virtual environment presented to the user, the region of the physical environment that is encompassed by the passthrough portal may be within the FOV of the cameras imaging the physical environment. Therefore, the portion of the video feed of the cameras of the HMD corresponding to the position of the passthrough portal may be displayed in the passthrough portal, allowing the user to maintain awareness of that region of the physical environment by looking at the passthrough portal.

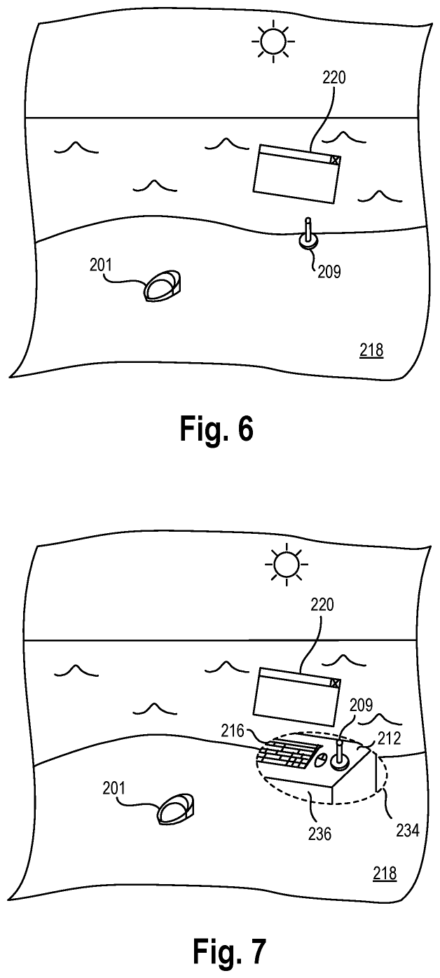

FIG. 6 through FIG. 10 illustrate examples of passthrough portals according to the present disclosure. FIG. 6 is a schematic view of a virtual environment 218 presented to a user on a HMD 201. The user (represented by the HMD 201) may interact with the virtual environment 218 and/or virtual elements 220 with an input device 209. As described herein, the user may place the input device 209 at rest on a surface in the physical environment. When the system identifies that the input device 209 is resting on a flat surface, a passthrough portal 234 may be positioned horizontally (to mimic the surface orientation) in the virtual environment 218 around the input device 209, as shown in FIG. 7. The passthrough portal 234 may have a video feed 236 of a portion of the imaged physical environment displayed therein. For example, the HMD may image a FOV of the physical environment that corresponds to the FOV of the virtual environment 218 presented to the user, and only the portion of the video feed of the physical environment that corresponds to the location, size, and shape of the passthrough portal 234 may be shown in the video feed 236 of the passthrough portal 234. In the illustrated example, the passthrough portal 234 is positioned and sized to provide a video feed 236 of a portion of the desk 212 and the keyboard 216 in the user's office.

The passthrough portal 234 may have any shape. For example, the passthrough portal 234 may be a circle, a rectangle, a triangle, an ellipse, any regular polygon, irregular shape, or combinations thereof. For example, FIG. 7 illustrates an embodiment of a passthrough portal 334 that is a circle and may be resized. For example, a user can resize the passthrough portal 234 with the input device 209 to present a video feed 236 of only the desired portion of the physical environment. As such, the passthrough portal 234 may occupy less of the virtual environment 218, allowing more space for interaction with virtual elements 220 while retaining the awareness of the physical environment the user wants.

At least a portion of the movement of the user in the virtual environment may be movement of the user in the physical environment. For example, one or more sensors may detect movement of the HMD in the physical environment, and the perspective of the virtual environment provided to the user in the HMD may update to simulate movement in the virtual environment based on the movement in the physical environment. In such examples, the position of the passthrough portal 234 may remain fixed relative to the input device 209 and/or the surface in physical environment when the user moves relative to the physical environment.

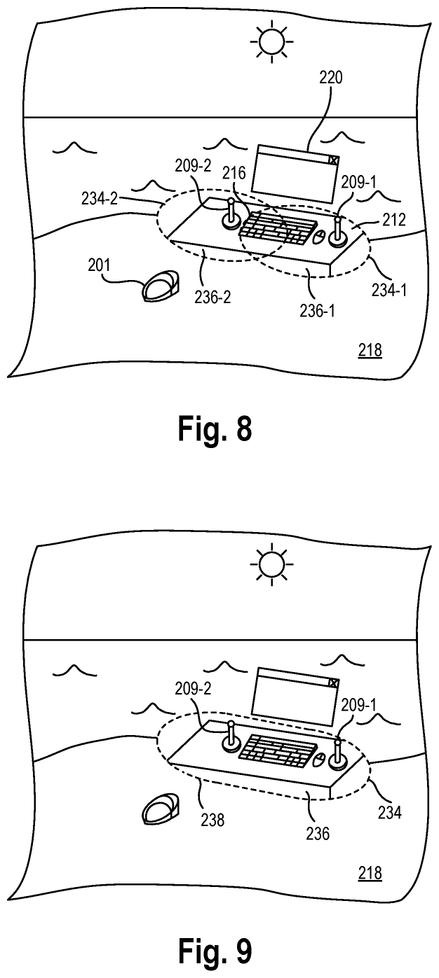

In some instances, the passthrough portal 234 positioned at the surface may provide only a portion of the video feed on interest to the user. FIG. 8 illustrates the HMD 201 in the virtual environment 218 of FIG. 7, with a first input device 209-1 and a second input device 209-2 in communication with the HMD 201 and both the first input device 209-1 and second input device 209-2 on the desk 212. A first passthrough portal 234-1 shows a first portion of the video feed 236 from the outward facing camera(s) of the HMD 201 while a second passthrough portal 234-2 shows a second portion of the video feed 236. The passthrough portals 234-1, 234-2 can overlap to provide a video feed of the entire keyboard 216 on the desk 212. The user may then be able to interact with the keyboard 216, for example, to input information to the application virtual element 220.

In some embodiments, the overlapping passthrough portals 234-1, 234-2 may be connected to form a single, larger passthrough portal. FIG. 9 illustrates the first input device 209-1 and the second input device 209-2 in proximity to one another such that the passthrough portals associated with each of input device 209-1, 209-2 overlap, and have joined in a bridge section 238. The bridge section 238 extends the edges of the passthrough portals tangentially toward one another to remove the constrictions between the passthrough portals. For example, when the input devices 209-1, 209-2 are both placed near one another (e.g., with overlapping passthrough portals), the system may infer that the surface between the input devices 209-1, 209-2 is of particular interest to a user. As motion controllers, in particular, are typically used in pairs, using a plurality of input devices 209-1, 209-2 to create a larger continuous passthrough portal may be advantageous. In other examples, more than two input devices 209-1, 209-2 may be used to combine passthrough portals to create a larger region of the video feed 236.

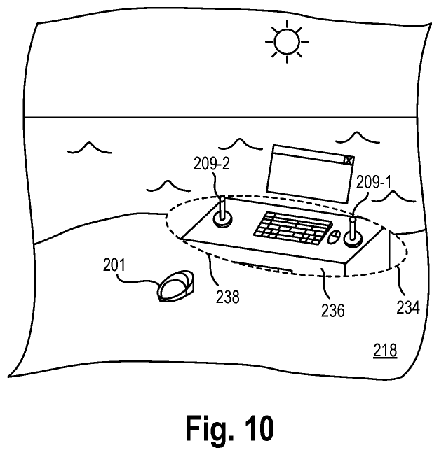

FIG. 10 illustrates the virtual environment 218 with the first input device 209-1 and second input device 209-2 positioned on the same physical surface but far enough, such that the passthrough portals associate with each input device 209-1, 209-2 would not overlap. However, when the system determines, either through depth imaging of the physical environment, through tracking of the input devices 209-1, 209-2, or through other means, that the input devices 209-1, 209-2 are positioned on the same physical surface, a passthrough portal 234 having a bridge 238 connecting the regions around the first input device 209-1 and second input device 209-2 may be created to provide a video feed 238 of the region therebetween. For example, the first input device 209-1 and second input device 209-2 may be positioned at either end of a desk or other surface in the physical environment bookending the surface of interest. The passthrough portal 234 may, therefore provide a video feed 236 to a user (represented by the HMD 201) that provides visual information of the full surface between the input devices 209-1, 209-2.

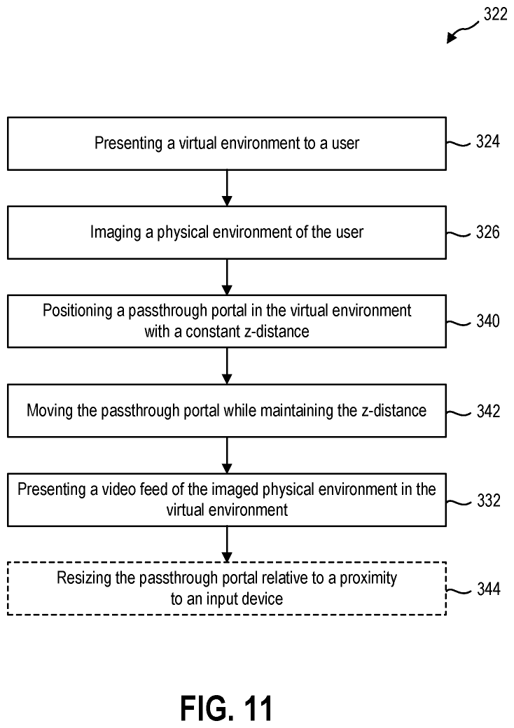

FIG. 11 is a flowchart illustrating another method 322 of providing visual information of a physical environment to a user in a virtual environment. The method 322 includes presenting a virtual environment to a user at 324 and imaging a physical environment of the user at 326. The virtual environment may be presented to the user and the physical environment may be imaged similarly as described in relation to FIG. 5.

The method 322 further includes positioning a passthrough portal in the virtual environment with a constant virtual z-distance relative to the user at 340. In some embodiments, the virtual z-distance is calculated from an origin positioned at the HMD. The passthrough portal may be projected at the constant virtual z-distance in a cone or other angular portion of a sphere around the origin. The constant virtual z-distance, as simulated by the stereo images produced by the near-eye display of the HMD, may alleviate discomfort or nausea associated with a video feed of the physical environment moving within the virtual environment. For example, some users experience disorientation or discomfort when a view of the physical environment (i.e., the real world) moves relative to the user in the virtual environment without the user physically moving.

By presenting the passthrough portal at a constant z-distance against a sphere projected from the origin at the HMD, the passthrough portal becomes a video feed of the user's perspective of the physical environment at a constant depth from the user. The method further includes moving the passthrough portal while maintaining the virtual z-distance as a constant at 342. The method further includes presenting the video feed of the imaged physical environment in the virtual environment at 332. The presentation of the video feed may be similar to that described in relation to FIG. 5.

As described, sudden movements of the “real world” within the virtual environment can be disorienting, while maintaining the z-distance relative to the user may alleviate some of the disorienting effects. In some examples, the passthrough portal may move in the virtual environment while remaining at a constant z-distance as the user (and the HMD) move relative to the virtual environment. In this manner, the passthrough portal may remain fixed relative to the POV of the user and the HMD. In other examples, the passthrough portal may move in the virtual environment while remaining at a constant z-distance when a user uses an input device to interact with or otherwise translate the passthrough portal along the sphere of constant z-distance (radius) relative to the origin of the user's POV and the HMD.

In some embodiments, the method 322 optionally includes resizing the passthrough portal relative to a proximity of an input device to the passthrough portal and/or of the input device to the origin. For example, the passthrough portal may change size as the user moves an input device (such as the user's hand, a motion controller, a mouse, a gesture across a touch-sensing device, or other input device) toward or away from the passthrough portal. For example, moving the input device toward the passthrough portal may increase the area of the passthrough portal, presenting a larger region of the video feed to the user, while moving the input device further from the passthrough portal may decrease the area of the passthrough portal. Such actions may be natural for a user, as reaching toward the passthrough portal intuitively indicates interest in the visual information shown in the passthrough portal, and the system may respond to the user's interest by displaying more visual information.

For some users, the opposite actions may be more intuitive. For example, the passthrough portal may be positioned in the virtual space based at least partially upon a ray cast from the input device to select a location. For some users, moving the input device further from selected location may intuitively feel like “stretching” the passthrough portal to enlarge the passthrough portal. Conversely, moving the input device toward the selected location and passthrough portal may intuitively feel like “compressing” the passthrough portal, resulting in reducing a size of the passthrough portal.

In another embodiment, the passthrough portal may change size as the user moves an input device (such as the user's hand, a motion controller, a mouse, a gesture across a touch-sensing device, or other input device) toward or away from the origin. For example, in a system that utilizes gestures of the user's hands as the input device, it may be more fluid and natural for a user to move their hands toward the HMD to enlarge the passthrough portal, similar to a familiar pinch-and-zoom feature mechanic of a touch-sensing device. The resizing response of the passthrough portal may be user selectable within the system.

In some embodiments, the resizing response to the position of the input device is linear. In other embodiments, the resizing response to the position of the input device is non-linear. For example, the changes in passthrough portal size when the input device is between 1 foot (30.48 centimeters) and 2 feet (60.96 centimeters) in front of the user (i.e., the comfortable holding position for the input device), the changes may be fine changes. Meanwhile, when the user moves the input device more than 2 feet from the user (i.e., reaches with a fully extended arm), the changes in passthrough portal size may be larger, as the sensitivity increases at the extremes of the movement.

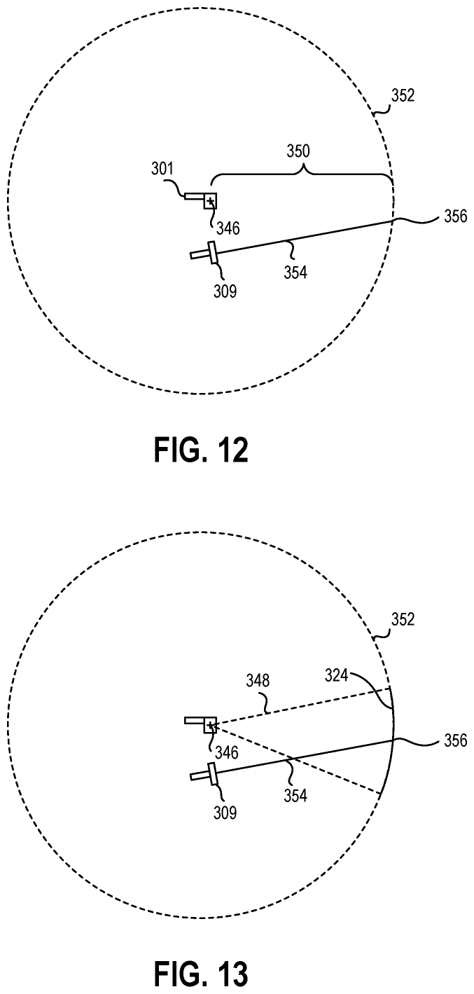

FIG. 12 is a schematic side view of a user (represented by the HMD 301) using an input device 309 to select a location for a passthrough portal at a constant z-distance from the user. The passthrough portal may be positioned at a constant z-distance 350 from the origin 346 based upon a sphere 352 defined by the z-distance 350 around the origin 346. The input device 309 casts a ray 354 that extends from the input device 309 and crosses the sphere 352 at a selected location 356.

FIG. 13 schematically illustrates the passthrough portal 324 created at the selected location 356 where the ray 354 crosses the sphere 352. The passthrough portal 324 is defined by a cone 348 emanating from the origin 346 outward toward the sphere 352. The passthrough portal 324 is positioned on the sphere 352 and may follow the curvature of the sphere 352 to maintain a constant z-distance from the origin 346. In other examples, the passthrough portal 324 may be a flat virtual element with at least one point that is located on the sphere, with the passthrough portal oriented normal to the origin 346. For example, the passthrough portal 324 may have a point positioned at the selected location 356 while the remainder of the passthrough portal is flat and outside of the sphere 352.

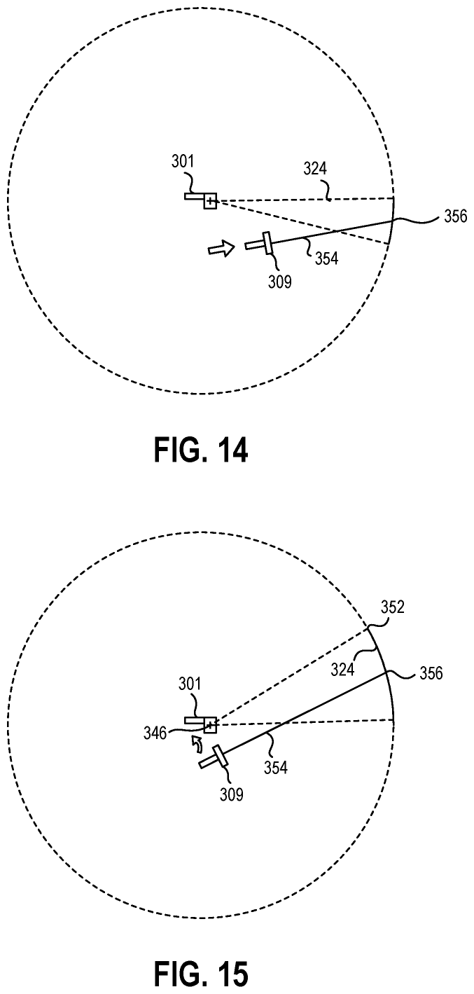

FIG. 14 illustrates moving the input device 309 relative to the passthrough portal 324 to resize the passthrough portal 324. FIG. 14 shows a user (represented by HMD 301) moving the input device 309 closer to the passthrough portal 324. As the length of the ray 354 to the selected location 356 shortens, a radius of the passthrough portal 324 around the selected location 356 shortens.

In FIG. 15, the user (represented by HMD 301) tilts the input device 309 upward. The new orientation of the input device 309 changes the orientation of the ray 354 and hence the selected location 356. Moving the selected location translates the passthrough portal 324 along the curvature of the sphere 352 based on the cone 348 emanating from the origin 346.

The passthrough portal may be created in the virtual environment at a shell level in the graphics pipeline or other processing or rendering pipeline. For example, the user may create, position, reshape, and resize the passthrough portal independently of any applications or virtual environment generated by the HMD or computing device in communication with the HMD. For example, the passthrough portal may persist as the user opens, closes, or changes applications. The passthrough portal may persist at the system desktop with no applications running. In at least one embodiment, interacting with the passthrough portal may expand the passthrough portal to the user's full FOV in the near-eye display, replicating a full field of vision while wearing the HMD. The expanded passthrough portal may be toggled between the passthrough portal element in the virtual environment and the full FOV to allow a user to maintain awareness of a region of the physical environment, such as a door or a desk; seamlessly transition to a full view of the physical environment to interact with the physical environment, as needed; and easily transition back to interacting with the virtual environment.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

It should be understood that any directions or reference frames in the preceding description are merely relative directions or movements. For example, any references to “front” and “back” or “top” and “bottom” or “left” and “right” are merely descriptive of the relative position or movement of the related elements.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method for presenting a physical environment in a virtual environment, the method comprising:
presenting a virtual environment to a user with a near-eye display;
imaging a physical environment of the user;
identifying at least one surface in the physical environment;
positioning a passthrough portal in the virtual environment, a position of the passthrough portal having a z-distance from the user in the virtual environment that is equal to a z-distance of the at least one surface in the physical environment; and
presenting a video feed of the physical environment in the passthrough portal in the virtual environment.

2. The method of claim 1, imaging the physical environment including using a depth camera.

3. The method of claim 1, imaging the physical environment including using an outward facing camera and presenting the video feed including using capturing the video feed with the same outward facing camera.

4. The method of claim 1, positioning the passthrough portal in the virtual environment including resizing the passthrough portal.

5. The method of claim 1, identifying at least one surface in the physical environment including detecting an input device at rest in the physical environment.

6. The method of claim 1, positioning the passthrough portal in the virtual environment including positioning the passthrough portal horizontally around the input device.

7. The method of claim 1, presenting the video feed including presenting a portion of a field of view (FOV) of a camera imaging the physical environment.

8. The method of claim 1, further comprising:
locating a first input device;
locating a second input device; and
positioning the passthrough portal with a bridge between the first input device and the second input device.

9. A system for presenting visual information to a user, the system comprising:
a near-eye display;
at least one outward facing camera;
an input device;
a processor in data communication with the near-eye display, the input device, and the outward facing camera; and
a hardware storage device in data communication with the processor, the hardware storage device having instructions stored thereon that, when executed by the processor, cause the system to:
present a virtual environment to a user,
image a physical environment of the user,
identify at least one surface in the physical environment using the outward facing camera,
position a passthrough portal in the virtual environment based on the location of the surface in the physical environment, and
present a video feed of the physical environment in the passthrough portal of the virtual environment.

10. The system of claim 9, the input device being a motion controller.

11. The system of claim 10, further comprising a second motion controller input device.

12. The system of claim 9, the input device including a gesture recognition device configured to recognize hand gestures of the user.

13. The system of claim 9, the instructions being executed at a shell level of the system.

14. A method for presenting a physical environment in a virtual environment, the method comprising:
presenting a virtual environment to a user with a head mounted display (HMD);
imaging a physical environment of the user with a camera of the HMD;
positioning a passthrough portal in the virtual environment at a sphere defined by a z-distance from an origin of the HMD;
moving the passthrough portal on the sphere at a constant z-distance; and
presenting a video feed of the physical environment in the passthrough portal in the virtual environment.

15. The method of claim 14, moving the passthrough portal including interacting with the passthrough portal with an input device.

16. The method of claim 14, further comprising changing a size of the passthrough portal as a distance from an input device to the passthrough portal changes.

17. The method of claim 16, changing a size of the passthrough portal including changing the size of the passthrough portal non-linearly as the distance from the input device to the passthrough portal changes.

18. The method of claim 14, the passthrough portal being curved to match the sphere.

19. The method of claim 14, positioning a passthrough portal in the virtual environment including positioning the passthrough portal at a selected location on the sphere.

20. The method of claim 19, further comprising selecting the selected location with a ray cast from an input device.
